(19) United States
(12) Patent Application Publication
(10) Pub. No.: US 2014/0198688 A1
(43) Pub. Date: Jul. 17, 2014

(54) Method and Apparatus for Reducing Self Interference

(71) Applicant: Broadcom Corporation, Irvine, CA (US)

(72) Inventors: Wei LI, Oulu (FI); Jorma Olavi LILLEBERG, Oulu (FI); Alok SETHI, Oulu (FI)

(73) Assignee: Broadcom Corporation, Irvine, CA (US)

(21) Appl. No.: 14/156,810

(22) Filed: Jan. 16, 2014

(30) Foreign Application Priority Data
Jan. 17, 2013 (GB) 1300878.4

(51) Int. Cl. H04L 5/14; H04B 1/44

(52) U.S. Cl. CPC H04L 5/1461; H04B 1/44
USPC 370/278

(57) ABSTRACT

A method, apparatus, and computer program product are provided to reduce self-interference in a transceiver. In the context of a method, a self-interference channel estimate may be determined. A reconstructed interference may further be determined based at least in part on the self-interference channel estimate and a signal to be transmitted and the reconstructed self-interference is caused to be subtracted from a received signal. According to a further embodiment, detection of a desired signal may be disabled while this process is repeated until a residual self-interference is below a threshold, at which point detection of the desired signal may be enabled.

### TECHNICAL FIELD

An example embodiment of the present invention relates generally to wireless communication and, more particularly, to reducing self-interference in a wireless transceiver.

### BACKGROUND

In traditional wireless communication systems, a transceiver may be transmitting and receiving either using different frequency bands or different time slots, e.g., in a half-duplex mode. If the transceiver were to operate simultaneously on an overlapped time and frequency resource, e.g., in a full-duplex mode, the high self-interference may saturate the receiver chain, making signal recovery difficult or even impossible. Accordingly, in the absence of effective self-interference technology, full-duplex transceivers have to date been regarded as impractical and difficult to implement in wireless communication systems.

### SUMMARY

Therefore, methods, apparatuses, and computer program products are provided according to example embodiments in order to effectively reduce self-interference. In this regard, a method, apparatus, and computer program product from the perspective of an analog baseband canceller (ABC) may determine a self-interference channel estimate, determine a reconstructed self-interference based on a signal to be transmitted and the self-interference channel estimate, and subtract the reconstructed self-interference from a received signal. According to a further embodiment, the ABC may iteratively repeat this process until the residual self-interference drops below a threshold, at which point detection of a desired signal may be initiated.

In one embodiment, a method is provided that includes determining a self-interference channel estimate, causing a reconstructed self-interference to be determined based at least in part on the self-interference channel estimate and a signal to be transmitted, and causing the reconstructed self-interference to be subtracted from a received signal. According to a further example embodiment, the method may include determining a residual self-interference based at least in part on a signal resulting from subtraction of the reconstructed self-interference from the received signal, determining whether the residual self-interference component is less than a threshold, and causing detection of a desired signal to be enabled in an instance in which the residual self-interference is less than the threshold.

In another embodiment, an apparatus is provided that includes a processing system, which may be embodied by at least one processor and at least one memory including program code. The processing system is arranged to cause the apparatus to at least determine a self-interference channel estimate, cause a reconstructed self-interference to be determined based at least in part on the self-interference channel estimate and a signal to be transmitted, and cause the reconstructed self-interference to be subtracted from a received signal. According to a further example embodiment, the apparatus may be further caused to determine a residual self-interference based at least in part on a signal resulting from subtraction of the reconstructed self-interference from the received signal, determine whether the residual self-interference component is less than a threshold, and cause detection of a desired signal to be enabled in an instance in which the residual self-interference is less than the threshold.

In a further embodiment, a computer program product is provided that includes a set of instructions, which, when executed by a processing system, causes the processing system to determine a self-interference channel estimate, cause a reconstructed self-interference to be determined based at least in part on the self-interference channel estimate and a signal to be transmitted, and cause the reconstructed self-interference to be subtracted from a received signal. The set of instructions may be embodied on a non-transitory computer readable medium storing computer program code portions therein. According to a further example embodiment, the set of instructions, when executed by the processing system, may cause the processing system to determine a residual self-interference based at least in part on a signal resulting from the subtraction of the reconstructed self-interference from the received signal, determine whether the residual self-interference component is less than a threshold, and cause detection of a desired signal to be enabled in an instance in which the residual self-interference is less than the threshold.

In another embodiment, an apparatus is provided that includes means for determining a self-interference channel estimate, means for causing a reconstructed self-interference to be determined based at least in part on the self-interference channel estimate and a signal to be transmitted, and means for causing the reconstructed self-interference to be subtracted from a received signal. According to a further example embodiment, the apparatus may further include means for determining a residual self-interference based at least in part on a signal resulting from the subtraction of the reconstructed self-interference from the received signal, means for determining whether the residual self-interference component is less than a threshold, and means for causing detection of a desired signal to be enabled in an instance in which the residual self-interference is less than the threshold.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 is a block diagram of a transceiver comprising a conventional radio frequency (RF) cancellation system;

FIG. 2 is one example of graph illustrating the impact of analog-to-digital-converter (ADC) resolution on self-interference;

FIG. 3 is a block diagram of a transceiver comprising a self-cancellation system according to an example embodiment;

FIG. 4 is a block diagram of a self-cancellation system including an apparatus configured in accordance with an example embodiment of the present invention;

FIG. 5 is a flowchart depicting operations performed by an apparatus configured in accordance with some embodiments of the present invention;

FIG. 6 is a block diagram of a self-cancellation system including an apparatus configured in accordance with an example embodiment of the present invention;

FIG. 7 is a block diagram of a self-cancellation system including an apparatus configured in accordance with an example embodiment of the present invention;

FIG. 8 is a block diagram of a self-cancellation system including an apparatus configured in accordance with an example embodiment of the present invention; and

FIG. 9 is a block diagram of an apparatus that may be embodied by or associated with a transceiver, and may be configured to carry out various operations according to example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or access point, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, an access point, or other network device.

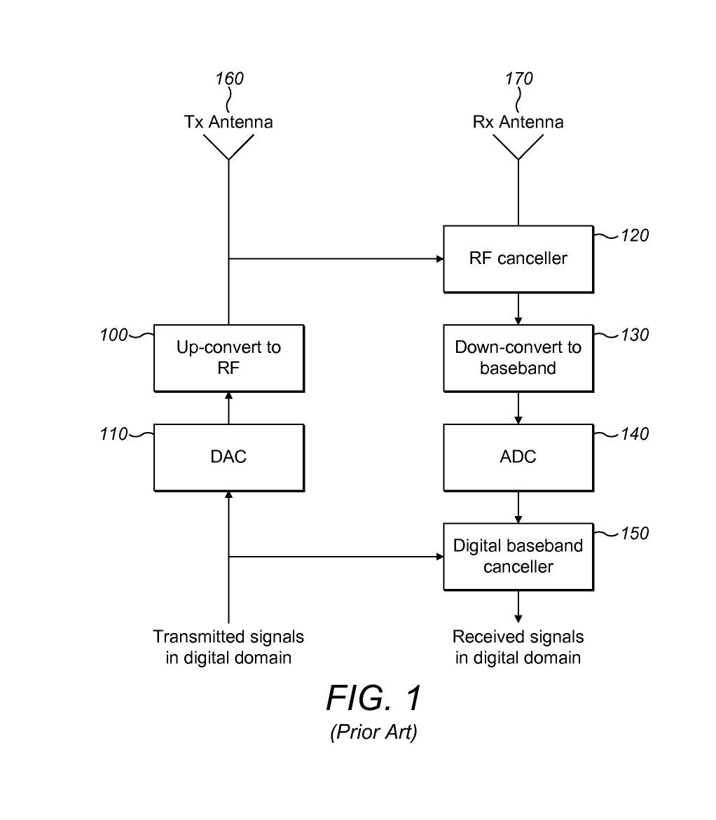

Referring now to FIG. 1, a transceiver that supports wireless communication is depicted. The transceiver may, for example, support communications between a user equipment (UE) and a network, such as a Universal Mobile Telecommunications System (UMTS) network, a Long Term Evolution (LTE™) network, an LTE-Advanced (LTE-A™) network, a Global Systems for Mobile communications (GSM™) network, a Code Division Multiple Access (CDMA) network, e.g., a Wideband CDMA (WCDMA) network, a CDMA2000™ network or the like, a General Packet Radio Service (GPRS) network or other type of network, via one or more access points (APs). As such, the depicted transceiver may, for example, be embodied by or otherwise associated with the UE and/or AP, and/or embodied by or otherwise associated with any other network entity capable of both transmitting and receiving wireless signals. As used herein, an access point refers to any communication device which provides connectivity to a network, such as a base station, an access node, or any equivalent, such as a Node B, an evolved Node B (eNB), a transmission point, a relay node, or other type of access point. The term “user equipment” includes any mobile communication device such as, for example, a mobile telephone, portable digital assistant (PDA), pager, laptop computer, a tablet computer, or any of numerous other hand held or portable communication devices, computation devices, content generation devices, content consumption devices, data card, Universal Serial Bus (USB) dongle, or combinations thereof. The communications between the user equipment and the access point may include the transmission of data via an uplink that is granted between the user equipment and the access point.

The conventional transceiver depicted in FIG. 1 thus includes a transmission antenna 160 and a reception antenna 170. Digital signals to be transmitted are converted to analog via the digital-to-analog-converter (DAC) 110. The resultant analog signal is then converted to a radio frequency (RF) signal via the RF up-conversion element 100 and transmitted via the transmission antenna 160. The transceiver receives RF transmission signals via the reception antenna 170. These RF signals are then down-converted to baseband via the down-conversion element 130 and the baseband signal is then converted to a digital signal via the analog-to-digital-converted (ADC) 140.

The conventional transceiver of FIG. 1 also contains RF cancellation and digital base band cancellation. With respect to the RF cancellation, RF signals for transmission are fed to both the transmission antenna 160 in the transmission chain and the RF canceller 120 in the reception chain. In this way, interference induced in the reception chain by the transmission chain (e.g., self-interference) can be accounted for and reduced somewhat. This type of conventional self-interference cancellation in the RF is mainly performed by passive components, and has certain limitations. For example, the RF cancellation element 120 used is ordinarily simple so as not to introduce too much loss, because it is ordinarily inserted before a low-noise amplifier (LNA).

Because of the simple design, the RF canceller 120 has a limited ability to reduce self-interference. Assuming that the distance between the transmission and reception antennas is about 10 cm, analog RF cancellation combined with the effects of path loss can achieve a reduction in self-interference of around 50 dB at a frequency of 2.4 GHz (using a near field path loss model provided by IEEE P802.15 working group for wireless personal area networks). Although analog RF cancellation may achieve about 50 dB of self-interference suppression, the RF canceller 120 is unable to deal with multipath components of self-interference and therefore leaves some self-interference un-canceled (e.g., residual self-interference). Moreover, this residual self-interference is frequently much stronger than the desired signal. To recover the desired signal, a conventional digital canceller can be utilized as depicted in FIG. 1. In this regard, digital signals for transmission are fed both to the DAC 110 in the transmission chain as well as to a digital baseband canceller 150 in the reception chain.

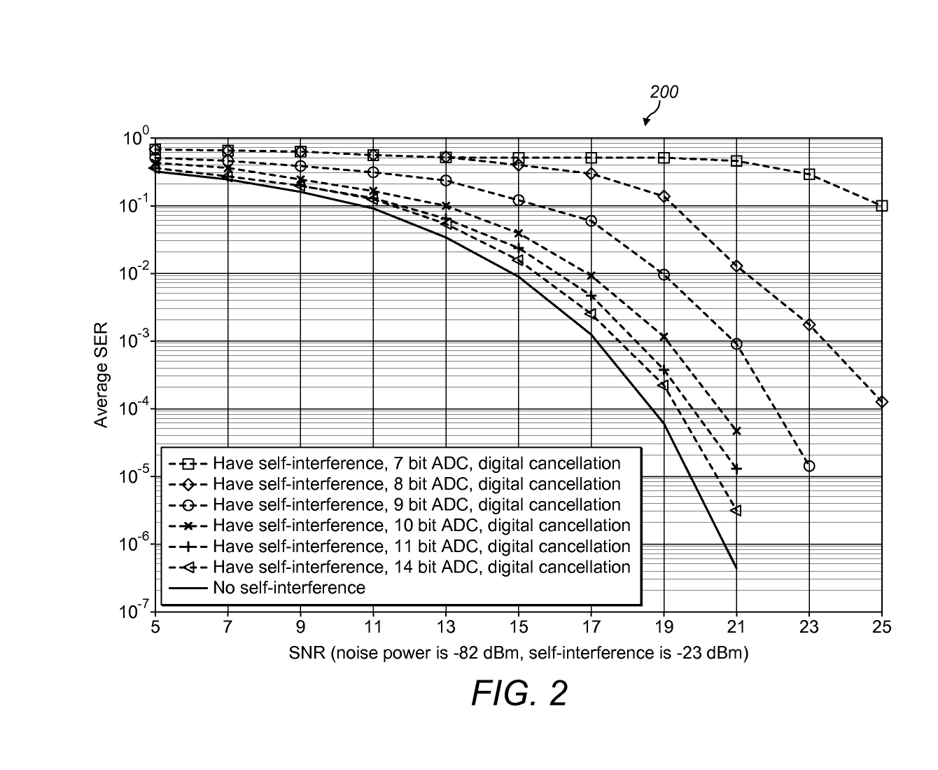

The effectiveness of including a conventional digital canceller in a transceiver, however, is still not ideal and can be seriously limited depending on the components used. To illustrate, consider the following example. There are two users being 50 meters apart from each other. Each user is using 1 transmission antenna and 1 reception antenna and the distance between the two antennas is 10 cm. The transmit power of each user is from −10 dBm to 20 dBm. The operating frequency is 2.4 GHz and the signal bandwidth is 20 MHz. In this scenario, the residual self-interference is about −55 to −25 dBm while the desired signal is about −80 to −50 dBm. Thus, the residual self-interference is still much stronger than the desired signal. As a result, a very high resolution analog-to-digital-converter (ADC) must be utilized. This effect is shown in the graph 200 of FIG. 2, which illustrates the impact of ADC resolution on final symbol error rate (SER) performance. As the graph 200 illustrates, for 4 pulse-amplitude modulated (PAM) real domain signals, an ADC resolution of at least 14 bits is necessary to guarantee the performance loss due to the residual self-interference is less than 1 dB. The cost of ADCs tends to rise with resolution and, thus, achieving desired residual self-interference reductions using a conventional digital canceller can result in relatively expensive devices.

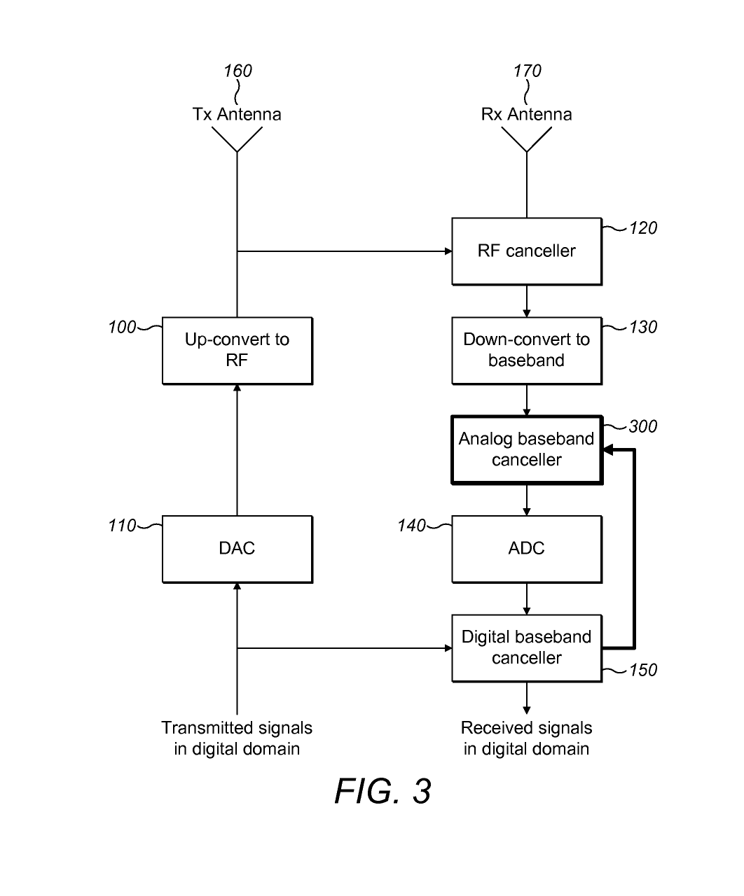

Turning now to FIG. 3, an overview of an improved self-interference cancellation scheme according to an example embodiment is depicted as it relates to the conventional transceiver depicted in FIG. 1. In this regard, the depicted self-interference cancellation scheme generally involves, via the analog baseband canceller (ABC) 300, reconstructing the analogue self-interference signal then cancelling it.

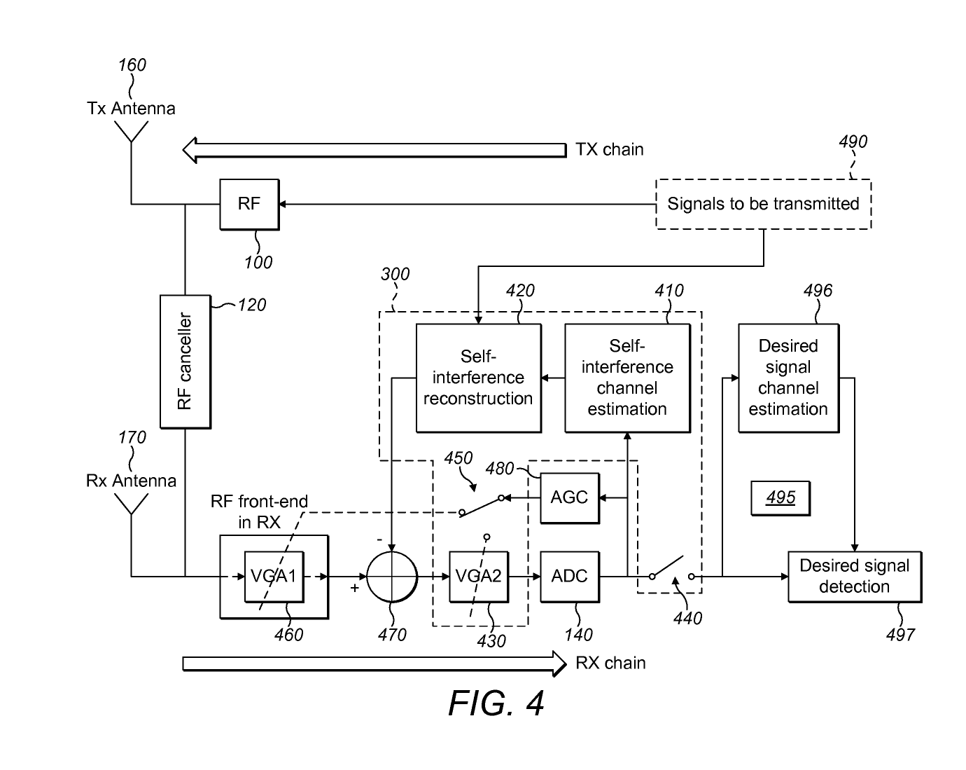

FIG. 4 presents a more detailed view of the ABC 300 and its various components according to an example embodiment, and illustrates how the ABC 300 may be operatively connected with some of the various other components of the transmission and reception chains. As shown in FIG. 4, the ABC 300 may comprise circuitry such as a self-interference channel estimation module 410, a self-interference reconstruction module 420, and a variable gain amplifier (VGA) 430. According to another example embodiment, the baseband canceller 300 may further comprise additional circuitry, such as first and/or second switching elements 440, 450.

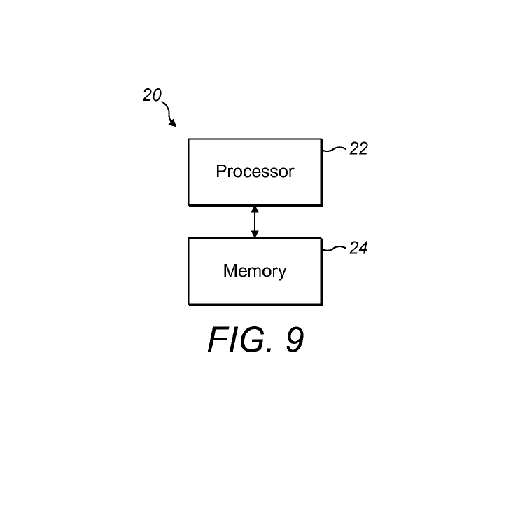

The self-interference estimation module 410 may, for example, comprise an apparatus, such as the apparatus 20 that is generally depicted in FIG. 9 and that may be configured in accordance with an example embodiment of the present invention as described below. However, it should be noted that the components, devices or elements described below may not be mandatory and thus some may be omitted in certain embodiments. Additionally, some embodiments may include further or different components, devices or elements beyond those shown and described herein.

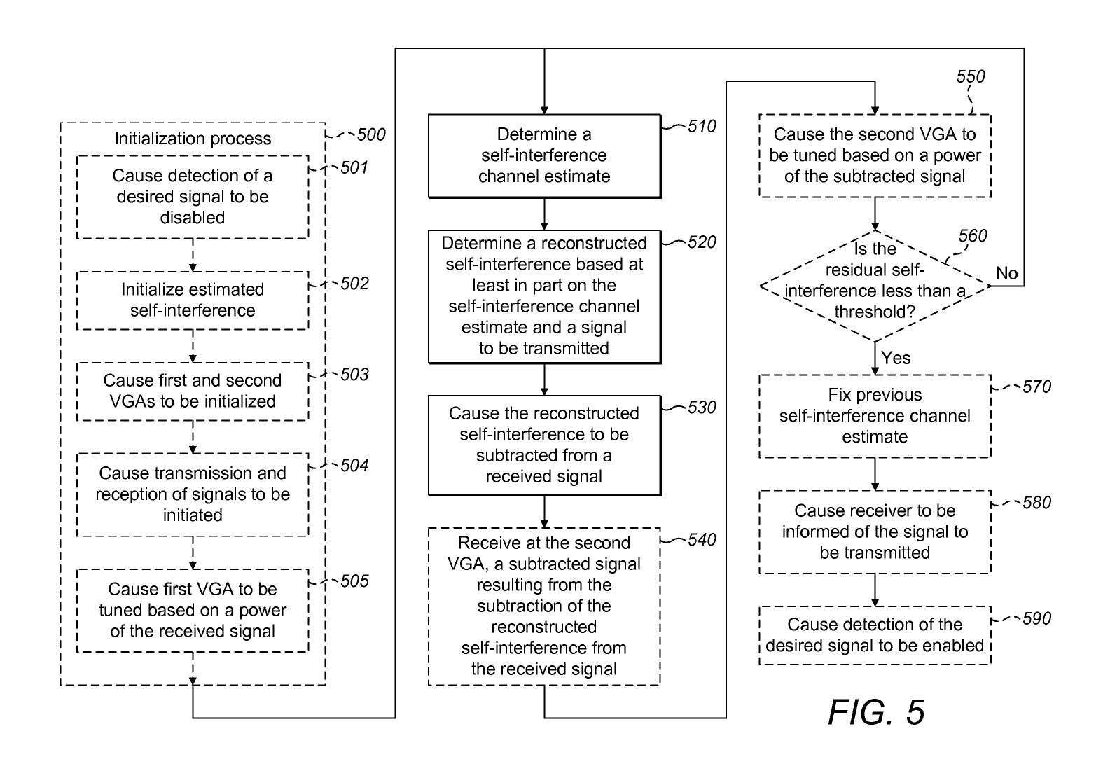

As shown in FIG. 9, however, the apparatus 20 may include or otherwise be in communication with a processing system, e.g., processing circuitry, such as the processor 22 and, in some embodiments, the memory 24, which is configurable to perform actions in accordance with some example embodiments described herein, such as in conjunction with FIG. 5. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the memory 24 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 22. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 22 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), DSP (digital signal processor), or the like. In an example embodiment, the processor may be configured to execute instructions stored in the memory 24 or otherwise accessible to the processor. As such, whether configured by hardware or by a combination of hardware and software, the processor may represent an entity (e.g., physically embodied in circuitry—in the form of processing circuitry) capable of performing operations according to some embodiments of the present invention while configured accordingly. Thus, for example, when the processor is embodied as an ASIC, FPGA, DSP or the like, the processor may be specifically configured hardware for conducting the operations described herein. Alternatively, as another example, when the processor is embodied as an executor of software instructions, the instructions may specifically configure the processor to perform the operations described herein.

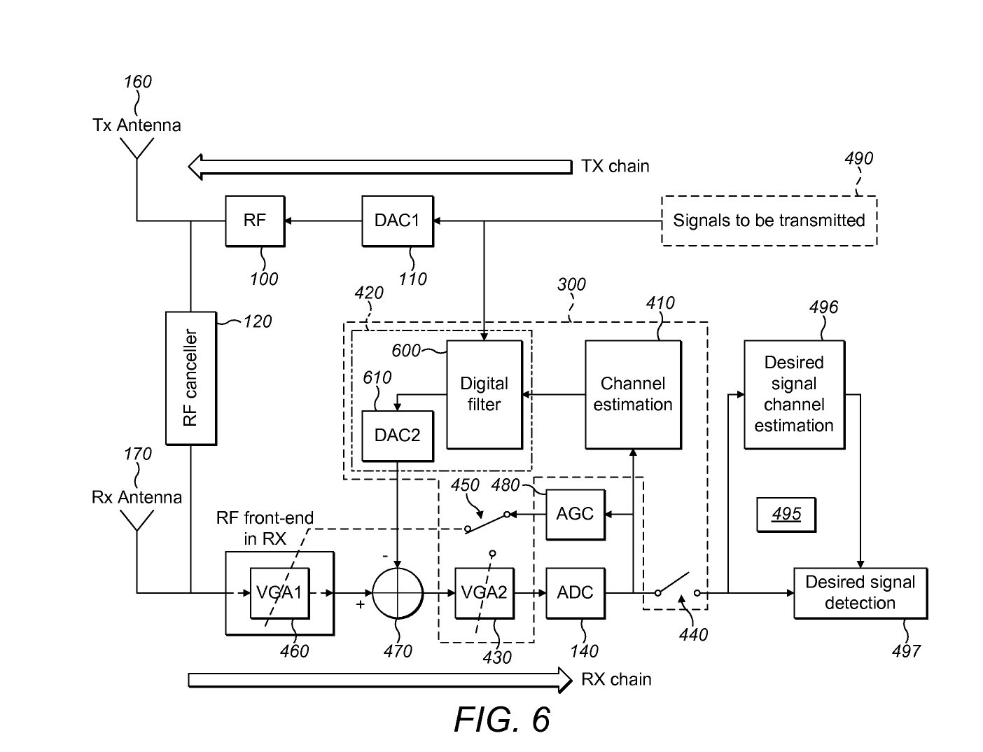

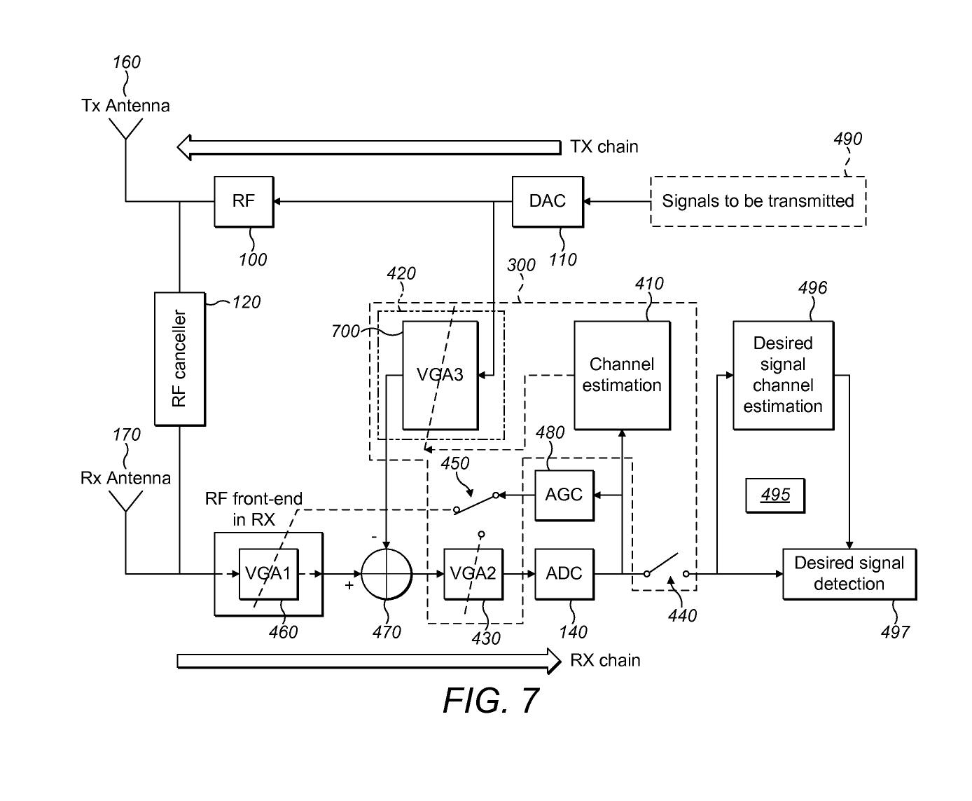

The self-interference reconstruction element 420 may comprise circuitry configured in various ways according to example embodiments. For example, the self-interference reconstruction element 420 may, as with the self-interference estimation module 410, comprise an apparatus, such as the apparatus 20 that is generally depicted in FIG. 9. According to another example embodiment, the self-interference reconstruction element 420 may comprise a digital filter element 600 and a digital-to-analog converter 610, as shown in FIG. 6 and as will be discussed further below. According to yet another example embodiment, the self-interference reconstruction element 420 may comprise a VGA 700 that is tuned, e.g., that has its gain controlled, by the output of the self-interference estimation module 410, as shown in FIG. 7 and as will also be discussed further below.

The switching elements may, for example, respectively comprise circuitry configured to act as a switch, such as one or more transistors, relays, or the like.

Thus having described various components that the ABC 300 may comprise, attention will be directed to FIG. 5, in which operations which may be performed by the ABC 300, or other components associated therewith, in accordance with an example embodiment are presented.

In this regard, and by way of a general overview, the operations of the ABC may be conceptualized as proceeding in two phases. The first phase is a “training” phase, in which the self-interference is reconstructed. In this training phase, a full-duplex transceiver including or otherwise associated with the ABC 300 may operate as a normal half-duplex transceiver (e.g., either transmitting or receiving, but not both at the same time). In this phase, a self-interference re-construction branch of the receiver chain is active, while a desired signal detection branch is inactive. After self-interference has been reconstructed to a suitable degree, such that subtracting it from the received signal results in a suitable reduction in residual self-interference, the second phase may be entered. In this phase, the desired signal detection branch is activated and the transceiver may thus operate in a full-duplex mode, transmitting and receiving signals at the same time, with reduced self-interference.

Thus, turning to FIG. 5, the ABC 300 may comprise means, such as circuitry, for performing various initialization procedures. See operation 500. For example, the ABC 300 may include means, such as the first switching element 440, for causing detection of a desired signal to be disabled. See operation 501. The ABC 300 may also, for example, include means, such as the self-interference estimation module 410 for initializing the self-interference channel estimate. See operation 502. The ABC 300 may, for example, cause the self-interference channel estimate to be initialized to a particular value, such as zero. The ABC 300 may also, for example, cause the second VGA 430 to be initialized. See operation 503. The second VGA 430 may, for example, be initialized to some default amplifying scale, such as zero dB. The first VGA 460 may also be initialized along with the second VGA. Transmission and reception of signals via the transmission and reception antennas 160, 170 may also begin during the initialization procedure. See operation 504. The ABC 300 may also, for example, include means, such as the second switching element 450, for causing the first VGA 460 to be tuned based on a power of the received signal. That is, the ABC 300 may cause, via switching element 450, an output of the automatic gain control (AGC) element 480 to be directed to a tuning input of the first VGA 460 (step 505).

The ABC 300 may further include means, e.g., circuitry, such as the self-interference estimation module 410, for determining a self-interference channel estimate. See operation 510. As discussed above, the self-interference estimation module 410 may itself comprise means, such as the processor 22 and memory 24 of apparatus 20 depicted in FIG. 9, for determining the self-interference channel estimate. According to an example embodiment, the signal to be transmitted 490 may be regarded as a training sequence for a conventional time domain or frequency domain channel estimation method to be used. For example, a least-squares channel estimation method may be used. According to an example embodiment, the self-interference channel estimate may be an updated self-interference channel estimate. That is, determining a self-interference channel estimate may comprise determining an updated self-interference channel estimate based on a previous self-interference channel estimate which may, for example, be stored in memory, such as the memory 24 of apparatus 20. As can be seen in FIG. 4, the self-interference channel estimate may be determined based on the output of the ADC 140.

The ABC 300 may further comprise means, e.g., circuitry, such as the self-interference reconstruction module 420, for determining a reconstructed self-interference. See operation 520. The self-interference reconstruction module 420 may itself comprise various means for determining the reconstructed self-interference, as discussed above, such as the processor 22 and memory 24 of apparatus 20 depicted in FIG. 9, a digital filter, a DAC, and/or a VGA. As shown in FIG. 4, the reconstructed self-interference is determined based at least in part on the output of the self-interference estimation module 410, e.g., a self-interference channel estimate or updated self-interference channel estimate, and a signal to be transmitted 490. As will be discussed further below, this signal to be transmitted 490 may, according to an example embodiment, be the original digital signal to be transmitted (e.g., before the signal is converted via the DAC 110 to an analog signal) or, according to another example embodiment, an analog form of the signal to be transmitted (e.g., after the signal is converted via the DAC 110 to an analog signal).

The ABC 300 may further comprise means, e.g., circuitry, such as the self-interference reconstruction module 420, for causing the reconstructed self-interference to be subtracted from a received signal. See operation 530. That is, the self-interference reconstruction module 420 may be further configured to output the reconstructed self-interference to a first input of a subtraction element 470, the subtraction element 470 receiving the received signal at a second input and comprising circuitry configured to subtract the first input from the second input. Thus, according to embodiments, reconstructed self-interference is determined based on the self-interference channel estimate and the signal to be transmitted and then is canceled from a received signal via subtraction.

The ABC 300 may further comprise means, e.g., circuitry, such as the VGA 430, for receiving a subtracted signal resulting from the subtraction of the reconstructed self-interference from the received signal. See operation 540. According to example embodiments, the second VGA 430 may further be configured to amplify the subtracted signal and output the amplified subtracted signal to the ADC 140.

The ABC 300 may further comprise means, e.g., circuitry, such as the switching element 450, for causing the second VGA 430 to be tuned based on a power of the subtracted signal. See operation 550. For example, the ABC 300 may cause, via switching element 450, an output of the AGC element 480 to be directed to a tuning input of the second VGA 430.

The ABC 300 may further comprise means, e.g., circuitry, such as the AGC element 480, for determining a residual self-interference. See operation 560. The AGC element 480 may be further configured to determine whether the residual self-interference is less than a threshold. See operation 560. In an instance in which the residual self-interference is not less than the threshold, the ABC 300 may return to operation 510 and determine, via the self-interference estimation module 410, a self-interference channel estimate, e.g., an updated self-interference channel estimate. Thus, the self-interference channel estimate and reconstructed self-interference may continue to be updated, and the reconstructed self-interference may continue to be subtracted from the received signal, until the residual self-interference is less than the threshold.

The AGC element 480 may be further configured to, in an instance in which the residual self-interference is less than the threshold, cause the self-interference channel estimate to be fixed. See operation 570. For example, the AGC element 480 may be configured to signal to the self-interference estimation module 410 that the residual self-interference is less than the threshold. Thus, the self-interference channel estimate may be fixed at the last determined value, such that it will remain unchanged when used for subsequent reconstructions of the self-interference via the self-interference reconstruction module 420.

A receiver may also be caused to be informed of the signal to be transmitted 490 in an instance in which the residual self-interference is less than the threshold, such as via the transmission antenna 160. See operation 580. The ABC 300 may further comprise means, e.g., circuitry, such as the first switching element 440, for causing detection of the desired signal to be enabled in an instance in which the residual self-interference is less than the threshold. For example, the ABC 300 may cause, via the first switching element 440, an output of the ADC 140 to be directed to the desired signal detection branch 495, which may, for example, comprise a desired signal detection module 496 and desired signal estimation module 497.

Having thus described the operations of the ABC 300 generally, attention will now be turned to FIGS. 6-8 in order to discuss specific example embodiments, including various example configurations of the self-interference reconstruction module 420.

As shown in FIG. 6, the self-interference reconstruction module may, according to an example embodiment, comprise circuitry such as a digital filter element 600 and a second DAC 610. Thus, according to an example embodiment, the digital filter 600 may be configured to generate a convoluted interference signal between the self-interference channel estimate, received from the self-interference estimation element, and the digital signal to be transmitted 490. According to one example embodiment, the digital filter element 600 may be configured to transform the self-interference channel estimate and the signal to be transmitted 490 into the frequency domain, multiply them, and then transform them into the time domain. According to another example embodiment, the digital filter element 600 may be configured to perform time domain convolution on the self-interference channel estimate and the signal to be transmitted 490. The digital filter 600 may be implemented in any number of ways, as will be apparent to a person of skill in the art. This convoluted interference signal may then be converted into an analog reconstructed self-interference signal via the second DAC 610.

As shown in FIG. 7, the self-interference reconstruction module may, according to another example embodiment, comprise circuitry such as a third VGA 700. The third VGA 700 may, alternatively, comprise a VGA chain. The self-interference channel estimate may thus be used to tune the third VGA 700. For example, the gain of the third VGA 700 may be determined based on the strongest path of the self-interference channel estimate. Thus, the VGA 700 may, for example, be configured to provide a multiplication function and, as such, other example embodiments may use other means besides a VGA to implement such a multiplication function.

One commonality between certain ones of the example embodiments discussed thus far is the use of the output of the AGC 480 to tune, e.g., control the gains of, the first VGA 460 and second VGA 430, and to use the second switching element 450 to toggle which VGA is tuned at any one time. While this switching scheme works suitably in full-duplex transceivers, it may be adapted to account for imbalances in bi-directional transmission time and to account for adaptive transmitter-side power control. With respect to the first issue, if a full-duplex transceiver using the switching scheme is going to stop its transmission, the self-interference signal may disappear from the tuning input of the first VGA 460. Consequently, its input signal power may weaken so that the gain of the first VGA 460 should be increased to reduce its noise figure impact. With respect to the second issue, the transmitter of a transceiver may adaptively change its transmit power during its transmission, making it beneficial for the AGC 480 to take own transmit power into account.

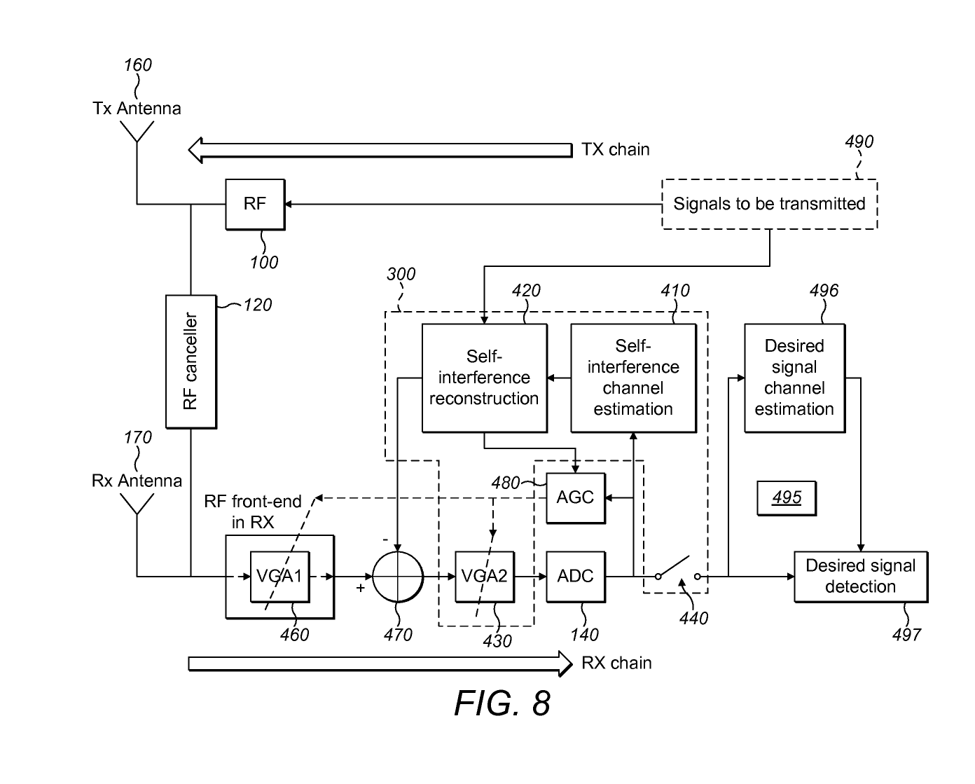

Based on these two concerns, an adapted AGC 480 scheme is presented in FIG. 8. As shown, the output of the AGC 480 may be used to tune the first VGA 460 and second VGA 430. Furthermore, the AGC 480 may, as depicted, be configured to take an output of the self-interference reconstruction module 420 into account. In this way, both the first VGA 460 and second VGA 430 may be tuned quickly and precisely. Thus, according to an example embodiment, the first VGA 460 and second VGA 430 may be initialized as per operation 503 of FIG. 5, as described above, but at the same time. Subsequently, the AGC 480, being configured to do so, may determine a change in transmit power based on the output of the self-interference reconstruction module 420. Then, according to another example embodiment, the AGC 480 may adjust the gain of the first VGA 460 according to the change in transmit power. For example, the AGC 480 may be configured to cause the gain of the first VGA 460 to be tuned down in an instance in which the transmit power has increased, and/or to cause the gain of the first VGA 460 to be tuned up in an instance in which the transmit power has decreased. The AGC 480 may, for example, be configured to tune the gain of the first VGA 460 based on the change in transmit power at the beginning of each frame or subframe.

Some embodiments according to the invention may provide many benefits in a wireless communication system. For example, the ABC 300 may reduce self-interference, thereby improving the overall performance of a full-duplex transceiver. Moreover, some embodiments of the present invention may achieve this without the use of an expensive, high-resolution ADC. For example, the performance realized from using an ABC 300 comprising an 8 bit ADC according to example embodiments of the present may be quite close to that realized by using a traditional digital base band cancellation and a 14 bit ADC.

As discussed above, FIG. 5 is a flowchart illustrating the operations performed by a method and apparatus, such as the ABC 300 of FIGS. 4 and 6-8, in accordance with an example embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures depicted in the flowchart of FIG. 5 and described above may be embodied by computer program instructions. In this regard, the computer program instructions which embody one or more of the procedures described above may be stored by a memory 24 of an apparatus embodied by or otherwise associated with an embodiment of the present invention and executed by a processor 22 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, one or more of the operations of FIG. 5, when executed, convert a computer or processing circuitry into a particular machine configured to perform an example embodiment of the present invention. Accordingly, one or more of the operations of FIG. 5 define an algorithm for configuring a computer or processing circuitry, e.g., processor, to perform an example embodiment. In some cases, a general purpose computer may be provided with an instance of the processor which performs one or more operations of the algorithm of FIG. 5 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions, or special or general-purpose circuitry, or any combination thereof.

In some embodiments, certain ones of the operations above may be modified or further amplified. Moreover, in some embodiments additional optional operations may also be included, some of which are shown in dashed lines in FIG. 5. It should be appreciated that each of the modifications, optional additions or amplifications may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for use in a transceiver comprising:
determining a self-interference channel estimate;
causing a reconstructed self-interference to be determined based at least in part on the self-interference channel estimate and a signal to be transmitted; and
causing the reconstructed self-interference to be subtracted from a received signal.

2. The method of claim 1, further comprising:
determining, based at least in part on a signal resulting from subtraction of the reconstructed self-interference from the received signal, a residual self-interference;
determining whether the residual self-interference is less than a threshold; and
in an instance in which the residual self-interference is less than the threshold, causing detection of a desired signal to be enabled.

3. The method of claim 2, further comprising, in an instance in which the residual self-interference is not less than the threshold:
determining, based at least in part on the self-interference channel estimate and the signal resulting from subtracting the reconstructed self-interference from the received signal, an updated self-interference channel estimate; and
causing an updated reconstructed self-interference to be determined based at least in part on the updated self-interference channel estimate and the signal to be transmitted.

4. The method of claim 2, wherein the self-interference channel estimate comprises a previous self-interference channel estimate and further comprising, in an instance in which the residual self-interference is less than the threshold, fixing the self-interference channel estimate.

5. The method of claim 4, further comprising, in an instance in which the residual self-interference is less than the threshold:
causing an updated reconstructed self-interference to be determined based at least in part on the fixed self-interference channel estimate and the signal to be transmitted.

6-14. (canceled)

15. An apparatus for use in a transceiver, the apparatus comprising a processing system comprising at least one processor and at least one memory, wherein the processing system is arranged to cause the apparatus to:
determine a self-interference channel estimate;
cause a reconstructed self-interference to be determined based at least in part on the self-interference channel estimate and a signal to be transmitted; and
cause the reconstructed self-interference to be subtracted from a received signal.

16. The apparatus of claim 15, wherein the processing system is further arranged to cause the apparatus to:
determine, based at least in part on a signal resulting from subtraction of the reconstructed self-interference from the received signal, a residual self-interference;
determine whether the residual self-interference is less than a threshold; and
in an instance in which the residual self-interference is less than the threshold, cause detection of a desired signal to be enabled.

17. The apparatus of claim 16, wherein the processing system is further arranged to cause the apparatus to:
determine, based at least in part on the self-interference channel estimate and the signal resulting from subtracting the reconstructed self-interference from the received signal, an updated self-interference channel estimate; and
cause an updated reconstructed self-interference to be determined based at least in part on the updated self-interference channel estimate and the signal to be transmitted.

18. The apparatus of claim 16, wherein the processing system is further arranged to cause the apparatus to, in an instance in which the residual self-interference is less than the threshold, fix the self-interference channel estimate.

19. The apparatus of claim 18, wherein the processing system is further arranged to, in an instance in which the residual self-interference is less than the threshold:
cause an updated reconstructed self-interference to be determined based at least in part on the fixed self-interference channel estimate and the signal to be transmitted.

20. The apparatus of claim 16, wherein the processing system is further arranged to cause the apparatus to, in an instance in which the residual self-interference is less than the threshold, cause a transceiver to be informed of the signal to be transmitted.

21. The apparatus of claim 15, wherein the processing system is further arranged to cause the apparatus to:
cause detection of a desired signal to be disabled;
initialize the self-interference channel estimate to 0; and
cause a first variable gain amplifier (VGA) and a second VGA to be initialized to respective default amplifying scales.

22. The apparatus of claim 15, wherein the processing system is further arranged to cause the apparatus to cause a first VGA to be tuned based on a signal power of the received signal.

23. The apparatus of claim 15, wherein the processing system is further arranged to cause the apparatus to cause a second VGA to be tuned based on a power of a signal resulting from subtraction the reconstructed self-interference from the received signal.

24. The apparatus of claim 15, wherein the received signal comprises an analog baseband signal.

25. The apparatus of claim 15, wherein the apparatus is caused to cause the reconstructed self-interference to be determined based at least in part on the self-interference channel estimate and the signal to be transmitted by causing the self-interference channel estimate to be provided to a digital filter.

26. The apparatus of claim 15, wherein the apparatus is caused to cause the reconstructed self-interference to be determined based at least in part on the self-interference channel estimate and the signal to be transmitted by causing a third VGA to be tuned based on the self-interference channel estimate.

27. The apparatus of claim 15, wherein the apparatus is further caused to cause the first and second VGA to be simultaneously tuned based on an output of an automatic gain control element.

28. The apparatus of claim 15, wherein the transceiver is embodied by a user equipment or an access point of a wireless communication system.

29. A computer-readable memory for use in a transceiver, the computer-readable memory comprising a computer-executed program code, the computer program code portions being arranged to, upon execution, cause the apparatus to at least:
determine a self-interference channel estimate;
cause a reconstructed self-interference to be determined based at least in part on the self-interference channel estimate and a signal to be transmitted; and
cause the reconstructed self-interference to be subtracted from a received signal.

30-56. (canceled)
